(19) United States
(12) Patent Application Publication
(10) Pub. No.: US 2007/0018374 A1
(43) Pub. Date: Jan. 25, 2007

(54) Sheet merging mechanism and method

(76) Inventors: William H. Gunther, Mystic, CT (US); James Hough, Mystic, CT (US); Charles Chadwick, Mystic, CT (US)

Correspondence Address: WILLIAM COLLARD;COLLARD & ROE, P.C., 1077 NORTHERN BOULEVARD, ROSLYN, NY, 11576, US

(21) Appl. No.: 11/184,234

(22) Filed: Jul. 20, 2005

(51) Int. Cl. B42B 2/00

(52) U.S. Cl. 270/52.02

(57) ABSTRACT

A sheet handling mechanism having a pair of set removal mechanisms, each set removal mechanism is adapted to remove sets from a cassette. A sensing mechanism senses data on the sets in the cassettes and stores the data. The data on each of the sets being removed from a cassette is sensed. A mechanism for merging a set of one cassette with a set of another cassette is provided to merge the two cassettes together.

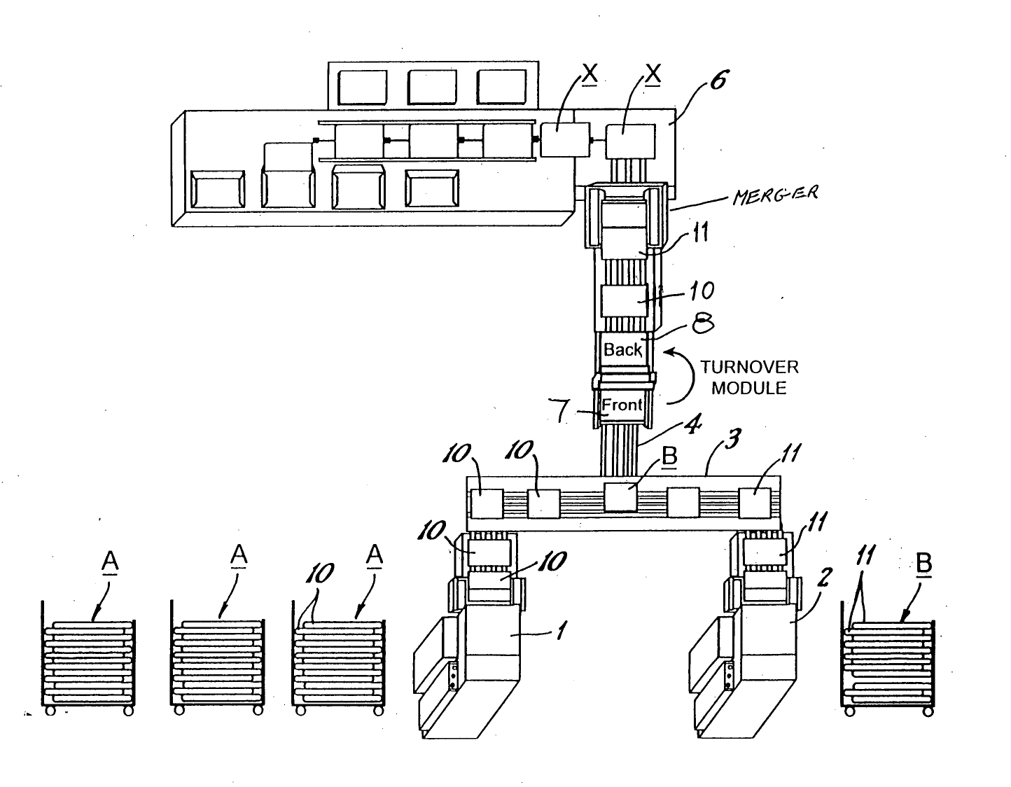

### BACKGROUND

The present invention relates to printing and assembling of groups of sheets of paper (hereinafter called sets) into finished documents (hereinafter called “books” and more particularly relates to merging of such sets of printed black and white sheets (hereinafter “black/white”) with sets or sheets of a different color (hereinafter “color”), such as a cover, to complete a book. As used herein, the term “sets” refers to a group of many sheets as well as a single sheet. The term “sets” may also be an entire book or portions of an entire book which will form the entire book when merged with other sets.

This application is an improvement over applicant's U.S. Pat. Nos. 6,192,295 and 6,324,442, the entire contents of which are incorporated herein by reference.

A large part of printing of books are, or will be, made with black/white sheets interspersed with pages of a different color and/or with a cover of a different color. There are in existence printers that produce both full color sheets and black/white sheets. However, the cost of printing both the black/white sheets and the color sheet on these printers is greater so that the operation of such printers is an expensive one. There are other machines (known as booklet machines) which create a color cover for a set and then bind the two together to form a book. In order to make sure the book and the cover match, these machines read data on the book and data on the cover and then feed them together through a binding machine. Such machines do not read the document when it is being printed and rely on manually feeding the covers in the proper sequence so that they match the book that the cover is applied to. There is no data matching a set of black/white sheets with its color cover during the printing operation. This is done strictly by matching the color cover and the black/white set as they are about to be joined together.

### OBJECTS

The present invention overcomes these problems and has for one its objects the provision of an improved merging mechanism which will permit black/white sheets to be merged with color sheets automatically and in the right position.

Another object of the present invention is the provision of an improved merging mechanism for merging different portions of books.

Another object of the present invention is the provision of an improved merging mechanism for merging black/white sheets with color sheets at the proper locations.

In order to accomplish these objects the invention comprises reading each black/white sheet, or preselected sheets, of a set and each color sheet, or preselected sheets, of a set as it is being printed and reading them again when they are assembled together to verify the correctness of the data.

Other and further objects of the invention will be obvious upon an understanding of the illustrative embodiment about to described, or will be indicated in the appended claims and various advantages not referred to herein will occur to one skilled in the art upon employment of the invention in practice.

### DRAWINGS

A preferred embodiment of the invention has been chosen for purposes of illustration and description and is shown in the accompanying drawings forming a part of the specification, wherein:

The single FIGURE in the drawings shows a simplified schematic diagrammatic plan view showing the mechanism and method of the present invention.

### DESCRIPTION

The present invention is adapted to use the cassettes and methods shown and described in said U.S. Pat. Nos. 6,192,295 and 6,324,442 for handling and assembling sheets of paper.

In general, these two earlier patents disclose feeding of a set of sheets in offset fashion to a cassette that has been inverted to reverse the sets. Each set comprises a number of sheets that are fed from a printer to the cassette. When the cassette is filled with a plurality of offset sets the cassette is again inverted so that the first printed set is at the top and the last printed set is at the bottom and thereafter the cassette is moved to a removal module which removes or extracts the sets from the cassette from the top down and feeds the sets to another machine for other operations to be performed on the set.

Referring to the drawing, there is provided a pair of cassettes A and B. Cassette A is filled with offset black/white sets 10 made up of a plurality of black/white sheets. Cassette B is filled with offset color sets 11 made up of a plurality of color sheets.

The mechanism and method of the present invention comprises a pair of removal modules 1 and 2 which will remove each black/white set 10 from a black/white cassette A and each color set 11 from the color cassettes B. There are frequently more black/white cassettes A then there are color cassettes B. The removal modules 1 and 2 will remove each set 10 and 11 out of the cassettes A and B, respectively, and place them onto a conveyor mechanism 3. Each of the removal modules 1 and 2 is connected to a database computer (not shown) and each is provided with a sensing device (not shown) which reads data on each of the sets 10 and 11 being removed from the two cassettes A and B. The database in the computer will advise the removal modules 1 and 2 to remove a predetermined number of black/white sets 10 and thereafter to remove a color set 11 which will be merged with the black/white set 10 either to act as a cover or to be interleaved as part of a book.

As shown in the drawings, a conveyor assembly 3 has a section 4 at right angles thereto which will move the sets 10 and 11 to a turnover module (which may be any well known turnover module) having portions 7 and 8 where the sets 10 and 11 are turned over. The color set 11 is placed on the first portion 7 of the turnover module. The color set 11 is turned over to the second portion 8 of the turnover module so that the top is now at the bottom. The black/white sets 10 are treated in the same manner. They are moved to the first portion 7 and turned over into the second portion 8. The sets 11 and 10 are moved to a merger mechanism (which may be any well known merging mechanism) where the sets 11 and 10 are merged together to form a book X. The conveyor assembly section 4 now moves the completed books X to a conveyor mechanism 6 which moves the completed books X to other stations where the books X may be subjected to other operations, such as insertion into an envelope.

In the operation of the present invention, two groups of black/white color cassettes A and B are placed at the pair of removal modules 1 and 2, respectively. The removal module 1 will remove black/white sets from the black/white cassettes A. The data on black/white sets A is read by sensors and transmitted to a computer. The computer will direct the removal module 1 to remove black/white sets 10 from the black/white cassette A and place them on the conveyor mechanism 3. At the proper place, the computer will instruct the removal module 2 to remove a color set 11 from the color cassette B and place it on the conveyor mechanism 3 to be merged with the proper black/white sets 10 at the merger mechanism. Hence, whenever a color set 11, which may be either a single page, such as a cover, or one or more interleaving pages, must be merged with the black/white sets 10, the computer advises the removal module 2 to remove a color set 11 from the color cassette B so that the color set 11 (cover or interleaving page/pages) may be merged with a black/white set 10. Since the cassettes A and B have already been inverted before each set 10 or 11 is removed therefrom, the sets 10 and 11 must again be turned over at the turnover module. If the color set 11 is a cover, it is first moved to the merger mechanism. Thereafter the black/white set 10 is moved to the merger mechanism and is merged with the color cover 11 so that it sits on top of the color cover 11. If color set 11 comprises one or more color sheets to be interleaved with the black/white sets 10, the color set 11 will be fed either before or after the black/white set 10 so that they sit on top of the black/white set or below it.

It is also possible that the black/white sets 10 are printed in such an order that it is not necessary to turn them over to get the pages in the proper order. In this event, the turnover module may be eliminated, or inactivated, and the black/white sets and color sets are fed to and merged by the merger mechanism without first turning them over.

The complete book X now moves to the conveyor mechanism 6 at which point the book X (which now includes a color cover and/or all color sheets which are interleaved within it) may be further processed, such as insertion into an envelope.

It will thus be seen that the present invention provides an improved merging mechanism which will permit black/white sheets to be merged with color sheets automatically and in the right position, which will merge different portion of books, and which merge black/white sheets with color at the proper locations.

As many and varied modifications of the subject matter of this invention will become apparent to those skilled in the art from the detailed description given hereinabove, it will be understood that the present invention is limited only as provided in the claims appended hereto.

The embodiments of the invention in which an exclusive property or privilege is claimed are defined as follows:

1. A sheet handling mechanism comprising a pair of set removal mechanisms, each set removal mechanism adapted to remove sets from a cassette, means for sensing data on the sets in the cassettes, means for storing said data, means for sensing the data on each of the sets being removed from a cassette, a merger mechanism responsive to said stored data for merging a set of one cassette with a set of another cassette.

2. A sheet handling mechanism as set forth in claim 1 wherein a pair of removal mechanisms are provided to remove sets from separate cassettes.

3. A sheet handling mechanism as set forth in claim 2 wherein a predetermined one of said cassettes has sets of a color different than the color of the other cassette.

4. A sheet handling mechanism as set forth in claim 3 wherein said data storing means controls the removal of the sets from each of the cassettes.

5. A sheet handling mechanism as set forth in claim 4 wherein said data storing means controls the removal of a set from one of said cassettes and controls the time for the removal of a set from the other cassette.

6. A sheet handling mechanism as set forth in claim 5 wherein a turnover mechanism is provided to invert the sets.

7. A sheet handling mechanism as set forth in claim 6 wherein said turnover mechanism is provided in advance of merge mechanism.

8. A sheet handling mechanism as set forth in claim 7 wherein a predetermined cassette has sets of a color different than the color of the sets in the other cassette and wherein the sets in said predetermined cassette comprise a cover of a book.

9. The method of handling sheets comprising stacking sets of sheets in a plurality of cassettes, removing the sets from said cassettes, sensing data on each of the sets, storing said data, sensing the data on each of the sets being removed from a cassette, and merging a set of one cassette with a set of another cassette responsive to the said stored data.

10. A sheet handling method as set forth in claim 9, wherein sets are removed from a pair of separate cassettes.

11. A sheet handling method as set forth in claim 10 wherein a predetermined one of said cassettes has sets of a color different than the color of the sets in the other cassette.

12. A sheet handling method as set forth in claim 11 wherein said stored data controls the removal of the sets from each of the cassettes.

13. A sheet handling method as set forth in claim 12 wherein said stored data controls the removal of a set from one of said cassettes and controls the removal of a set from the other of said cassette.

14. A sheet handling method as set forth in claim 11 wherein the sets are inverted.

15. A sheet handling mechanism as set forth in claim 14 wherein the sets are inverted before they are merged.

16. A sheet handling method as set forth in claim 53, wherein the sets of one cassette comprise a cover of a book.
